(19) United States
(12) Patent Application Publication
(10) Pub. No.: US 2005/0189722 A1
(43) Pub. Date: Sep. 1, 2005

(54) Mechanical seal

(76) Inventor: Alan James Roddis, Sheffield (GB)

Correspondence Address: MYERS BIGEL SIBLEY & SAJOVEC, PO BOX 37428, RALEIGH, NC, 27627, US

(21) Appl. No.: 11/057,525

(22) Filed: Feb. 14, 2005

(30) Foreign Application Priority Data
Feb. 13, 2004 (GB) GB0403235.5

(51) Int. Cl. F16J 15/34

(52) U.S. Cl. 277/400

(57) ABSTRACT

A mechanical seal includes at least one self-aligning member and has the capability to modify fluid flow radially inwardly of the self aligning member. The fluid flow may be modified by one or more of cutwater or pumping vanes/grooves in an eccentric arrangement.

### RELATED APPLICATION

This application claims the benefit of and priority to Great Britain Patent Application No. GB0403235.5 filed Feb. 13, 2004, the disclosure of which is hereby incorporated herein by reference.

### FIELD OF THE INVENTION

The invention relates to mechanical seals, especially mechanical seals with a so-called self aligning mechanism.

### BACKGROUND OF THE INVENTION

A mechanical seal comprises a “floating” component which is mounted axially movably around the rotary shaft of, for example a pump and a “static” component which is axially fixed, typically being secured to a housing. The floating component has a flat annular end face, i.e. its seal face, directed towards a complementary seal face of the static component. The floating component is urged towards the static component to close the seal faces together to form a sliding face seal, usually by means of one or more springs. Alternatively, instead of one or more springs, a metal bellows unit may be employed as the floating component.

In use, one of the floating and static components rotates; this component is therefore referred to as the rotary component. The other of the floating and static components does not rotate and is referred to as the stationary component.

Those seals whose floating component is rotary are described as rotary seals. If the floating component is stationary, the seal is referred to as a stationary seal.

If the sliding seal between the rotary and stationary components are assembled and pre-set prior to despatch from the mechanical seal manufacturing premises, the industry terminology for this is “cartridge seal”. If the rotary and stationary components are despatched individually (unassembled) from the mechanical seal manufacturing premises, the industry terminology for this is “component seal”.

Cartridge seal assemblies generally contain a single member that axially positions the respective components that make up the seal assembly. This member is typically referred to as a cartridge sleeve. The cartridge sleeve is conventionally radially disposed to the mechanical seal faces and extends axially beyond the mechanical seal faces.

A mechanical seal with one rotary face and one stationary face is referred as single seal. If there are two rotary faces or two stationary faces used in a mechanical seal assembly, it is referred as double seal.

Mechanical seals are used to prevent the leakage of a media, which is referred as product media, from one side of the sealing faces to the other side, on a rotary shaft, however it is known in the industry that a very small amount of leakage through the seal face always happen. This leakage will also help to increase the life of the seal faces at the contacting areas. This pair of seal faces are extremely flat to each other and their flatness are measured in Helium light bands. Any distortion or deviation from this flatness can cause the mechanical seal to leak and be unfit for its intended duty and can increase the amount of the leakage through the seal faces, in which it is referred as seal failure.

One of the well-known disturbances is, when the rotating shaft is not aligned with the sealing housing. This means the rotary face will not have a parallel rotating axis to the centre of stationary face. In this situation, there will be over compression at one side of the sealing faces and separation on the other side of the sealing faces. The compression can wear off the sealing faces and separation increases the leakage. One method of overcoming this problem is described U.S. Pat. No. 4,509,762 and used a self-aligning seat for stationary seal.

The present invention is an improvement on U.S. Pat. No. 4,509,762, and uses the self-aligning mechanism in a double seal to prevent seal failure due to misalignment.

A double mechanical seal, which may also be cartridge mounted, provides extra security against leakage. For example, where a product to be sealed from the environment is noxious (e.g. an acidic or carcinogenic product), or the product media is very hot or very cold, or it has a large pressure differential in between OD & ID of the sealing faces, a double seal is used. Often it is essential to use a media, which is usually referred in the industry as “barrier media”, in between the primary and secondary pairs of sealing faces in a double seal.

The primary sealing faces are always in contact with the product media from outside and barrier media from the inside, or vice versa. The secondary sealing faces are therefore in contact only with barrier media from either inside or outside in a double seal.

The barrier media is used for one or combination of following reasons:
(i) to neutralise the more noxious of the product media,
(ii) to reduce the effect of high pressure from product media on primary sealing faces, by applying high pressure on barrier media, to reduce differential pressure at sealing faces,
(iii) to reduce or even in some cases to increase the temperature of the sealing faces, due to high or low Product media temperature, or dispensing the frictional heat generated from the sealing faces.

An improved circulation of the barrier media in the cavity in between the primary and secondary sealing faces provides a better heat dispensation to adjust the temperature on the sealing faces.

One of the major issues that is considered on designing a mechanical seal is to fit the sealing faces into a very small available space. Therefore this cavity area in between the primary and secondary sealing faces can be very tight and small and designing and fitting an adequate circulating system for barrier media requires some innovations.

There are many inventions in this regard, which for example use, a pumping vane device within the sealing chamber, eccentricity, a combination of cut-water and pumping vanes, a combination of eccentricity and cut-water or the use of a combination of pumping vanes, eccentricity and cut-water.

An object of the present invention is to improve on all above inventions by using a self-aligning seal face mechanism in combination with a cut-water, and/or eccentricity, and/or pumping vane used in a mechanical seal assembly.

### SUMMARY

According to a first aspect of the invention there is provided a mechanical seal assembly for sealing a rotatable shaft to a fixed housing, said seal having a first annular self-aligning member surrounding a shaft and attachable to a second stationary housing member, and a third annular member having a radial face for mating which preferably corresponds to a radial face of a fourth rotary member, said first and third members have a means for permitting relative pivotal movement about a first axis between said first and third members and about a second axis at right angles to the first axis between the first annular member and second stationary housing, the assembly further including means for modifying fluid flow radially inwardly of said first member.

Preferably the flow modifying means comprises a cut water in the form of a radially extending, part circumferential fin.

Even more preferably the cut water feature is located adjacent to a communication orifice between the inner and outer most radial parts of the stationary housing.

In an alternative embodiment of the invention the flow modifying means comprises a radially extending eccentric annular member.

Even more preferably the cut water feature and/or the eccentric annual feature is located adjacent to at least one radially extending feature on the rotating member.

In a further preferred embodiment the seal comprises at least one set of counter rotating seal faces, at least one of which one is mounted on the self-aligning device containing the cut water feature adjacent to at least one communication orifices between the inner most part and outer most part of gland/housing member.

Preferably the rotating seal face which is mounted on the self-aligning device is the stationary seat.

In a further preferred embodiment of the invention the seal comprises at least one set of counter rotating seal faces, one of said seal faces, preferably the stationary seat being mounted on a self-aligning device containing an eccentric stationary member adjacent to the rotating member. Preferably the rotating seal face that is mounted on the self-aligning device is the stationary seat.

In a further embodiment of the invention the rotatable member contains at least one circumferential radially displaced pumping vane.

In a further embodiment of the invention the mechanical seal includes two rotary assemblies with radial faces and two stationary assemblies.

Preferably the two stationary assemblies are positioned back to back and are arranged along the self-aligning ring member such that an annular gap channel is provided between the two stationary assemblies.

Even more preferably the stationary assemblies have the same axes of pivotal movement.

In a further embodiment of the invention the self-aligning ring is provided with at least one communication orifice extending from an inner surface to an outer surface, said orifice opening into the annular gap channel to allow access from the inside of the self-aligning ring to the outer surface of the self-aligning ring.

In a further embodiment of the invention the pivotal movement between the gland-insert member and the self-aligning ring within the stationary assemblies is generated by the use of at least two lugs or pins provided on at least the gland-insert or the self-aligning ring.

Preferably the lugs are common for the both of said stationary faces.

Even more preferably each of said lugs or pins is located around 180° away from the other lug or pin along the annular surface of the self-aligning ring.

Even more preferably still four lugs and/or or four pins or any combination of such are provided on the self-aligning ring. Preferably two lugs or pins are provided for each of said stationary faces, and wherein for each stationary face, one lug or pin is located at around 180° along the annular surface of the self-aligning ring from the other lug or pin.

Preferably the lugs or pins described are positioned such that they create a cut-water effect on the barrier media within the gap channel.

Even more preferably the lugs extending into the gap channel have a curved profile for facilitating the flow of barrier media into and out of this channel.

According to a further embodiment of the invention the rotational shaft or sleeve is eccentric to the centre of the two stationary faces, thereby creating a pressure differential in the barrier media resulting in flow from an orifice provided within the self-aligning ring into the gap channel located in the back of said stationary faces.

More preferably the distance between the rotational sleeve or shaft and the stationary faces is reduced by said eccentricity.

Even more preferably still the barrier media travels in the same rotational direction, along the gap channel, as the rotational shaft or sleeve.

In a further preferred embodiment of the invention the in and out ports' slots on the ring are used in an opposite way to as previously described, in which the barrier media flows into the gap channel from the orifices located in the area that the distance in between the shaft or sleeve and the said stationary faces are increased by the eccentricity, and the barrier media exits from the said gap channel from the other slot on the said self-aligning ring.

In a preferred embodiment of the invention the self-aligning ring is provided with at least one orifice to allow the barrier media to flow in or out of the channel gap in between the back of said two stationary faces and said self-aligning ring.

In a further preferred embodiment of the invention at least one pumping vane or groove is provided on the rotational shaft or sleeve for circulating the barrier media in the gap channel. Preferably the rotational shaft or sleeve is provided with at least one pumping vane and at least one pumping groove. Preferably the vane or groove is orientated parallel to the axis of rotation of the shaft or sleeve. Alternatively the pumping vane or groove is orientated at an angle to the axis of the rotation on the shaft or sleeve thereby providing an axial pumping effect on the barrier media. The vanes or grooves may be of the same or different sizes. The vanes or grooves may be orientated in the same or different axial directions.

In a further preferred embodiment of the invention the self-aligning ring assembly is comprises at least two parts.

A mechanical seal assembly according to any preceding claim, wherein the inner surface of the self-aligning ring is provided with at least one vane or groove for directing the flow of the barrier media.

In a still further preferred embodiment of the invention the in- and/or out-ports provided on the gland and/or gland insert are adapted to facilitate the flow of the barrier media into and out of the self aligning ring. Preferably the ports are substantially curved shaped.

In a yet further preferred embodiment of the invention the self-aligning ring extends underneath at least one of the stationary faces thereby directing the barrier media underneath the seal face.

The mechanical seal assembly according to the present invention may comprise a single seal, a double seal or a triple seal.

A mechanical seal assembly as substantially as herein described with reference to the accompanying drawings.

### BRIEF DESCRIPTION OF THE DRAWINGS

This is described by way of example only, with reference to the accompanying illustrative drawings, of which:—

FIG. 1 is a prior art, which illustrates a double seal design with one in-port and one out-port for the barrier media and one self-aligning ring on back of two stationary seal faces.

FIG. 2 is a longitudinal cross section through a double seal of the invention.

FIG. 3 corresponds to FIG. 2 and illustrates the cross sectional view of the invention concept to present the location of cut-water mechanism located just before the out-port at the bottom section of FIG. 2.

FIG. 4 illustrate a cross sectional view of a prior art seal without a self-aligning mechanism in operation.

FIG. 5 illustrate a cross sectional view of the current invention where a self-aligning mechanism is used to compensate the misalignment in between the rotary shaft and the seal housing.

FIG. 6 illustrate the self-aligning mechanism on a dual seal of a prior art system and few designs for the current invention.

FIG. 7 illustrate a longitudinal cross section and end view of the use of pumping vanes on the sleeve within this invention.

FIG. 8 illustrates a longitudinal cross section and end view of the use of eccentricity within the current invention.

FIG. 9 illustrates a longitudinal cross section and end view of the use of cut-water and eccentricity within the current invention.

FIG. 10 illustrates a longitudinal cross section and end view of the use of cut-water, eccentricity and pumping vanes within the current invention.

FIG. 11 illustrate the view of a gland and a gland-insert in this invention.

FIG. 12 illustrates the cross-sectional view of the barrier media into the seal as an example in the current invention.

FIG. 13 illustrates a longitudinal cross section of a sleeve with staggered pumping vanes and grooves on the current invention.

FIG. 14 illustrate a longitudinal cross section of an extended self-aligning mechanism under the seal faces, for a better barrier media path inside of the seal.

FIG. 15 illustrates a longitudinal cross section of the self-aligning mechanism in a single seal.

### DETAILED DESCRIPTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

It will be understood that when an element or layer is referred to as being “on,” “connected to,” or “coupled to” another element or layer, it can be directly on, connected, or coupled to the other element or layer or intervening elements or layers may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items. Like numbers refer to like elements throughout the description.

Furthermore, relative terms, such as “lower” or “bottom” and “upper” or “top” may be used herein to describe one element's relationship to another element as illustrated in the figures. It will be understood that relative terms are intended to encompass different orientations of the device in addition to the orientation depicted in the figures. For example, if the device in the figures is turned over, elements described as being on the “lower” side of other elements would then be oriented on “upper” sides of the other elements. The exemplary term “lower” can, therefore, encompass both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The skilled person will understand that the invention may be employed for different seal face arrangements in a double or triple mechanical seal whether designed in a cartridge seal or component seal format.

The invention may be used with metallic components as well as non-metallic components.

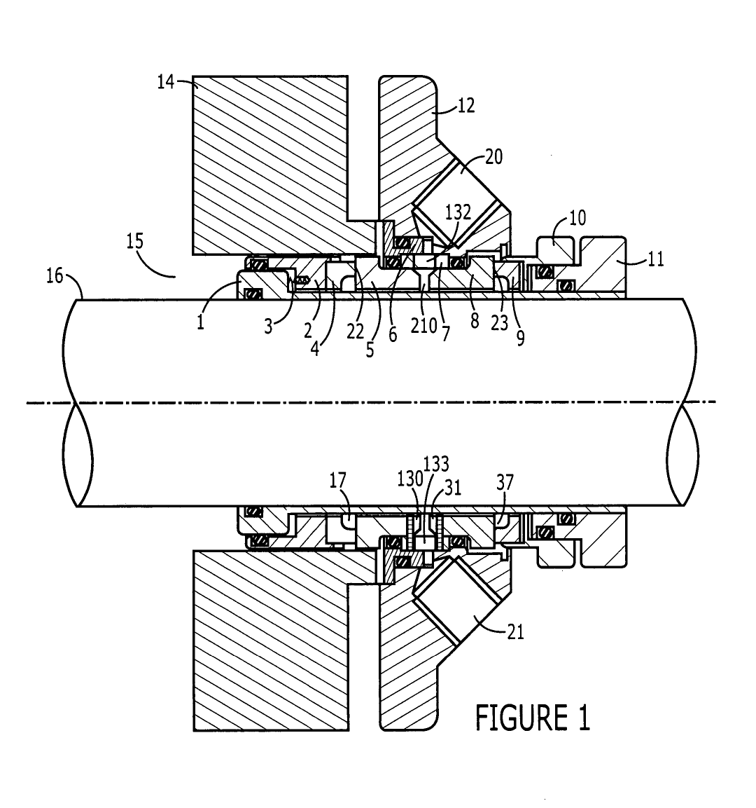

From FIG. 1, an experienced reader will note that the groove 132 in the self-aligning mechanism is the only way that allows the barrier media flow from in-port 20 to the gap channel 210 at the back of two stationary faces 5 and 7. The barrier media flows through this channel to the space in between underneath of the stationary faces and the sleeve, to the cavity 17 and 37 close to rotary faces 4 and 9 respectively. The barrier media is then flows out of this area through out-port 21. The pressure difference in between the in-port 20 and out-port 21 is the only mechanism that helps the Barrier media travel through the mechanical seal.

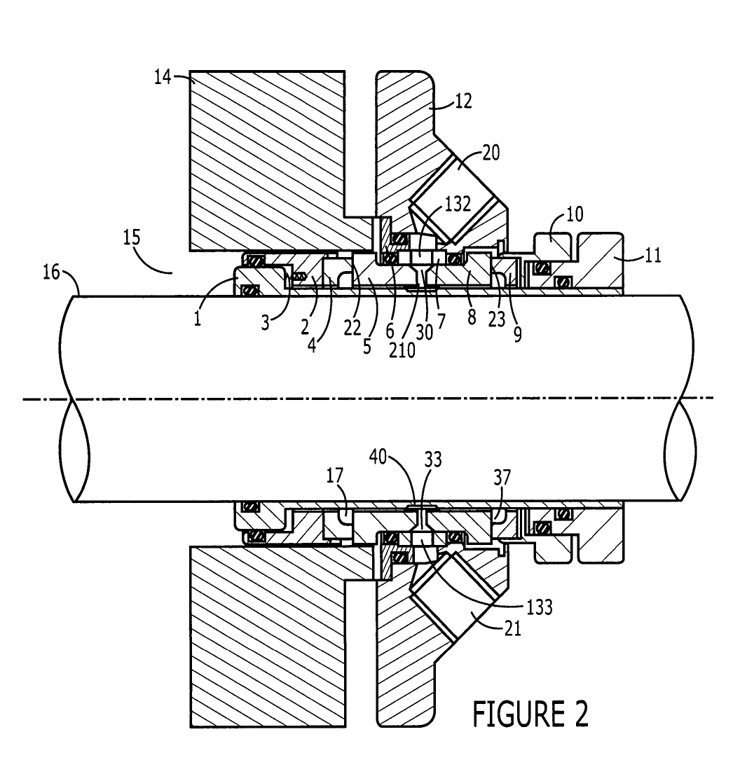

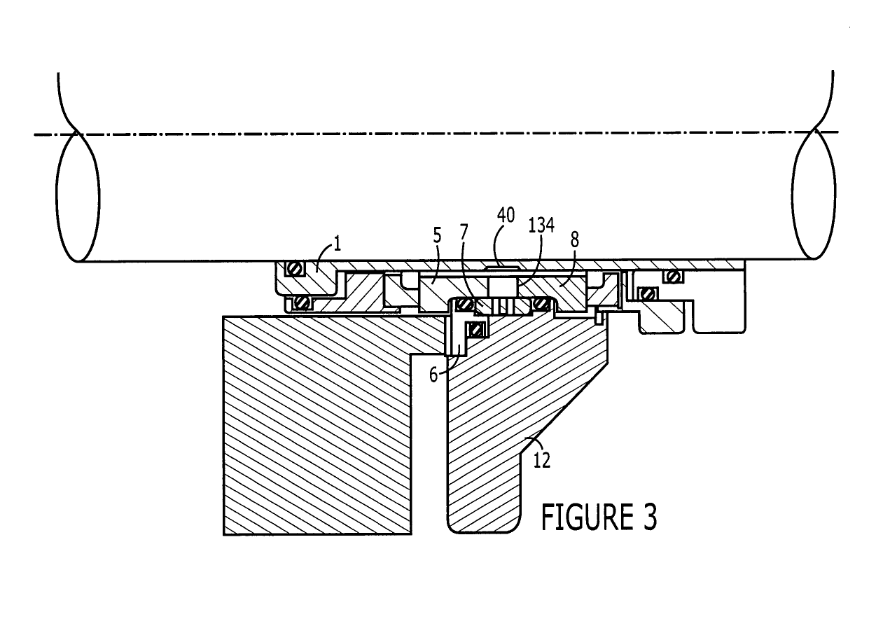

FIGS. 2 & 3 present the current invention by using the prior art self-aligning mechanism 7. This self-aligning ring is eccentric to the shaft as it is presented in these figures that space 30 is larger than space 33. A cut-water 34 and pumping vane 40 on the sleeve are also illustrated in FIG. 3. Self-aligning mechanism 7 compensates any misalignment in between the rotating sleeve 1 and the seal housing 12. This misalignment can also be in between the shaft 16 and the main housing 14 or any other combinations. The cutwater mechanism shown in FIG. 3 is by modifying the location of pins 130 in FIG. 1 to be away from the out-port 21 (in FIG. 2). The pins are in a larger size, to block the gap channel 210 to provide cutwater effect on barrier media.

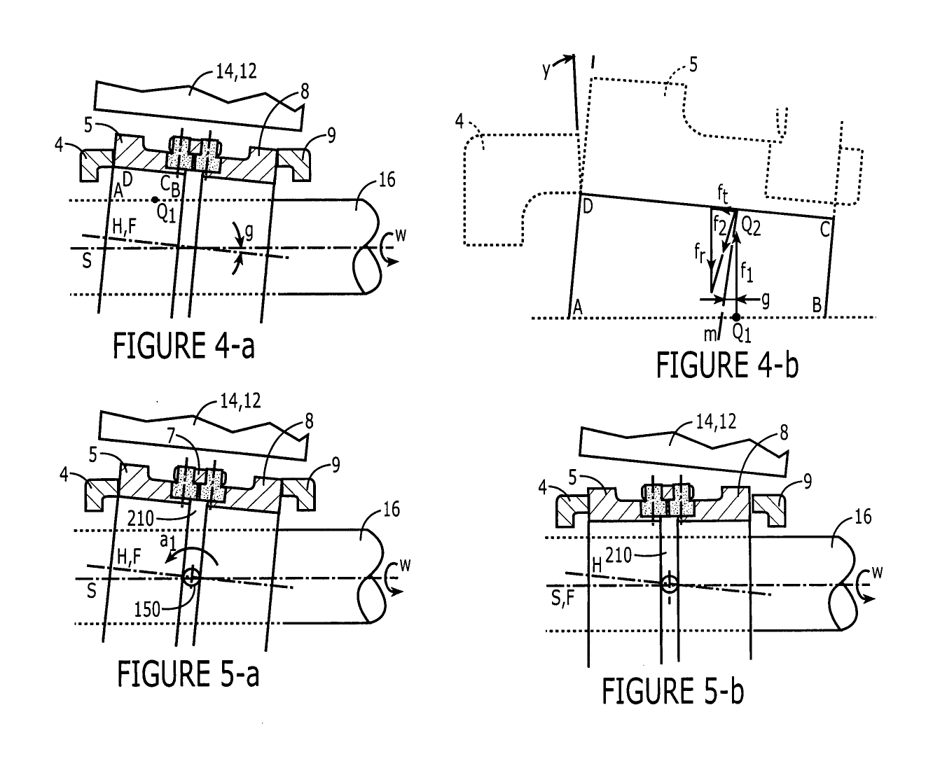

In a prior art design, where a self-aligning mechanism is not used, if there was a misalignment in between the rotary shaft axis and the housing axis, the faces will not be in full contact along their flat surfaces. This is presented in FIGS. 4-a & 4-b.

FIG. 4-a presents the rotating axis (S) of the shaft (16) is not parallel to the axis (H) of the housing (12, 14). The stationary faces are connected to the housing by the stationary assemblies and the axis (F) of the stationary faces (5, 8) will be aligned with axis (H) of the housing. This will cause the rotary faces 4 & 9 have a point contact with the stationary faces 5 & 8 respectively. This point contact is magnified for Faces 4 & 5 in FIG. 4-b. It is shown in FIG. 4-a that if the shaft and housing have a misalignment of g degrees, this will be projected on the contact surfaces in between the rotary face 4 and the stationary face 5 at the same amount of angle g in FIG. 4-b.

A centrifugal force is applied on the barrier media around the sleeve, during the seal operation, while the shaft is rotating. This is shown as an example on a particle Q₁ from barrier media in FIG. 4-a. Particle Q₁ is located in between the rotating shaft/sleeve 16 and stationary face 5. This particle is also located in the region marked ABCD in FIG. 4-a.

The region ABCD is magnified in FIG. 4-b, to clearly illustrate the movement of particle Q₁ in this region in a simple format. A radial/centrifugal force f₁ is applied on Particle Q₁ due to the shaft rotation. Due to this radial force, this particle will hit surface CD at Q₂. This particle will then deflect from this surface along f₂, which is symmetric to line f₁ based on line m. Line m is perpendicular to surface CD at point Q₂. The angle in between lines m and f₁ is equal to g, which is the misalignment angle in between the shaft and the housing. If the axis of the shaft or sleeve and the axis of the housing were aligned together, angle g will be equal to zero. In this situation, f₂ will be on top of f₁ but in an opposite direction. f₂ also represents the force that is applied on deflected barrier particle Q₂ after hitting surface CD.

In a situation when there is misalignment in between the shaft and the housing exists at angle g, it is shown in FIG. 4-b that force f₂ can be projected into two components: one is the radial force fᵣ and the other is a tangential force ft. Radial force fᵣ will cause the barrier particle Q₂ move towards the shaft, however force ft will cause the particle Q₂ to move away from line BC. It is clear from FIG. 1 compared to FIG. 4-a that the in-port or the out-port on the gland of the mechanical seal are around line BC in FIGS. 4-a and 4-b. Therefore in the top part of the seal (as shown in FIGS. 4-a & 4-b) the barrier particle is moving away from the seal's in-port. A similar state happens on the other half of the seal, where the barrier particle will be moving towards the seal's out-port.

One may argue this is useful on circulating the barrier media from the seal's IN-Port to underneath of the seal faces at the top half, then move the barrier media towards the out-port at the bottom half of the seal. This is very rare to happen and be beneficial as it is possible that the seal's out-port can be located at top part and the in-port being at the bottom part. In this case, the barrier media will be trapped in the seal and it will prevent the circulation of the barrier media in the mechanical seal. The misalignment in between the shaft and the housing can happen at any direction and it is not possible for definite to claim that the in-port always remain at top and the out-port always remain at the bottom as mentioned in the previous example. Therefore it is better to avoid relying on chance, and remove such axial force on barrier particles (fₜ) that is generated by misalignment in between the shaft/sleeve and the housing.

The best way of removing the axial force (fₜ) on the barrier particle Q₂ in FIG. 4-b is to get rid of the angle g. Angle g is the misalignment in between the shaft/sleeve 16 and the housing 14 in FIG. 4-a. The self-aligning ring 7 that is illustrated in FIGS. 5-a and 5-b would align the axis (F) of the stationary faces (5 & 8) to the axis of shaft (S) and eliminates angle g in between contacting surface in between rotary and stationary faces. This is done by rotating the stationary assembly around pin 150 in FIG. 5-a along a1 direction, when there is such a misalignment. In this case the axis (F) of the stationary faces 5 and 8, will be aligned with the axis (S) of the rotary shaft/sleeve 16 or the rotary faces 4 and 9, while the housing axis H still is not aligned with (S). In this situation no axial force is generated on barrier media particles, if such a misalignment exists in between the shaft/sleeve and the housing. Therefore it is possible now to adequately use other mechanisms for circulating the barrier media in the mechanical seal. These mechanisms are now designed within the self-aligning ring 7. Therefore this invention is based on improving the previous invention on self-aligning mechanism disclosed in U.S. Pat. No. 4,509,762, to include eccentricity, cut-water or pumping vanes on the sleeve, or any combination of them in the mechanical seal.

The present invention is also an improvement on the prior art that use any combination of eccentricity, cut-water or pumping vanes without a self-aligning mechanism in the mechanical seal, because the barrier media can become trapped in the seal chamber as a result of any misalignment between the shaft and the housing. Furthermore the seal faces will be in point contact which may result in damage leading to seal failure.

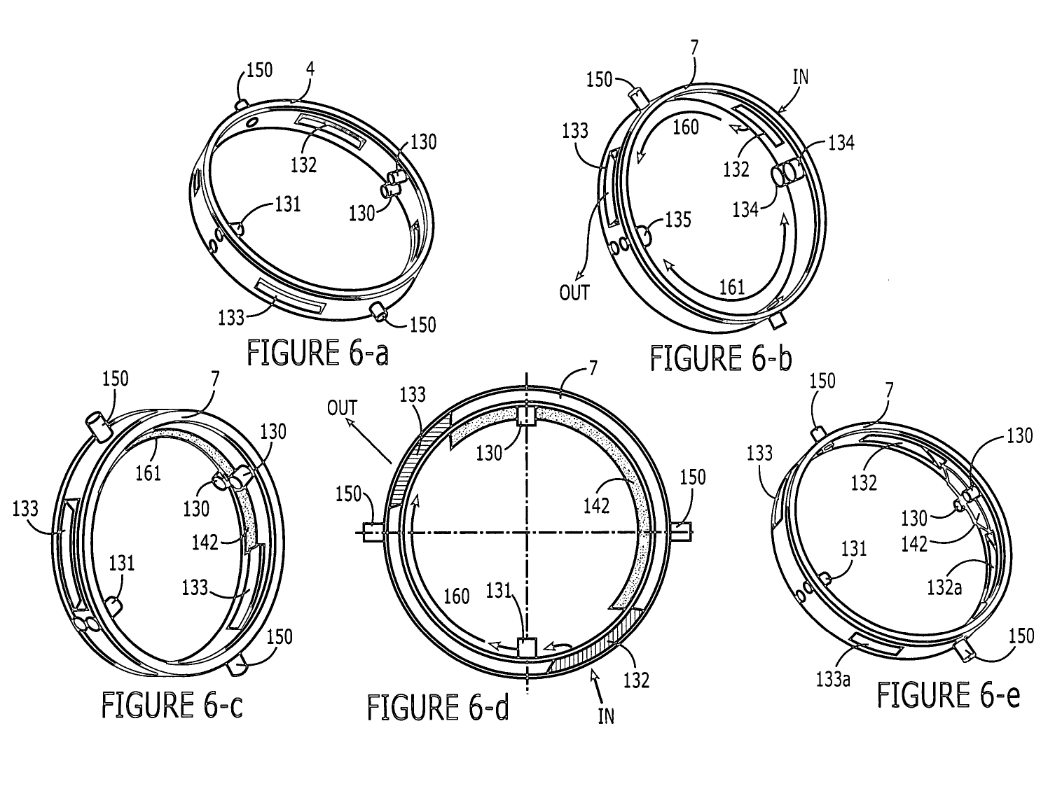

FIG. 6-a illustrates the prior art of using Self-Aligning mechanism in a double seal, and FIG. 6-b illustrates the current invention by moving and changing the size of the drive pins 130 and 131 to 134 and 135. These pins provide the cut-water mechanism effect on barrier media. The in-port 132 and out-port 133 in FIG. 6-b are slightly modified compared to FIG. 6-a. This is to allow the barrier media flow into the ring 7 from port 132, then travel along path 160 in between the sleeve and the ring. The barrier media is stopped by pins 135, which has the cut-water effect, and it is lead out of the ring 7 from out-port 133 in FIG. 6-b.

FIGS. 6-c and 6-d refer to a same ring from different view. The fin shaped section 142 on the ring 7 provides the cut-water concept in a more effective way. The edges on this fin have got a slight angle at the in-port 132 to lead the barrier media into the ring and then by using an angle at the end of this fin, it works in a better way as cut-water to lead the barrier media to out-port 133. The barrier media travels inside of the ring 7 along path 160.

FIG. 6-e illustrates a further embodiment of the self-aligning ring. A Shorter fin 142 compare to FIG. 6-c or 6-d on the ring 7 provides the cutwater concept in a more effective design. The position of in & out ports 132 & 133, are similar to FIG. 6-c, and the ports are formed radially in an angle to provide a better path for the barrier media stream. There are also two more ports in this ring to ease its assembly in the seal, despite the location of the in-port and out-port on the seal. However this design can also be used when the in & out ports of the Mechanical seal are located on a different angle compared to the ones illustrated here that are along the in & out ports of ring 7 in FIG. 6-b.

As an example, when the seal is in operation and the shaft rotates counter clock-wise (CCW) in FIG. 6-b, the barrier media flows from IN port 132 into the space between the ring 7 and sleeve. The barrier media then travels toward the out-port 133 along path 160. However some of the barrier media may travel longitudinally along the sleeve by using different mechanisms, to reach around the contact sealing faces. The path from the in-port to the out-port where, the barrier media is travels (160), is referred as up-stream. The space 161 behind the pins 134 & 135, where the barrier media is trapped in FIG. 6-b is referred as down-stream in the industry.

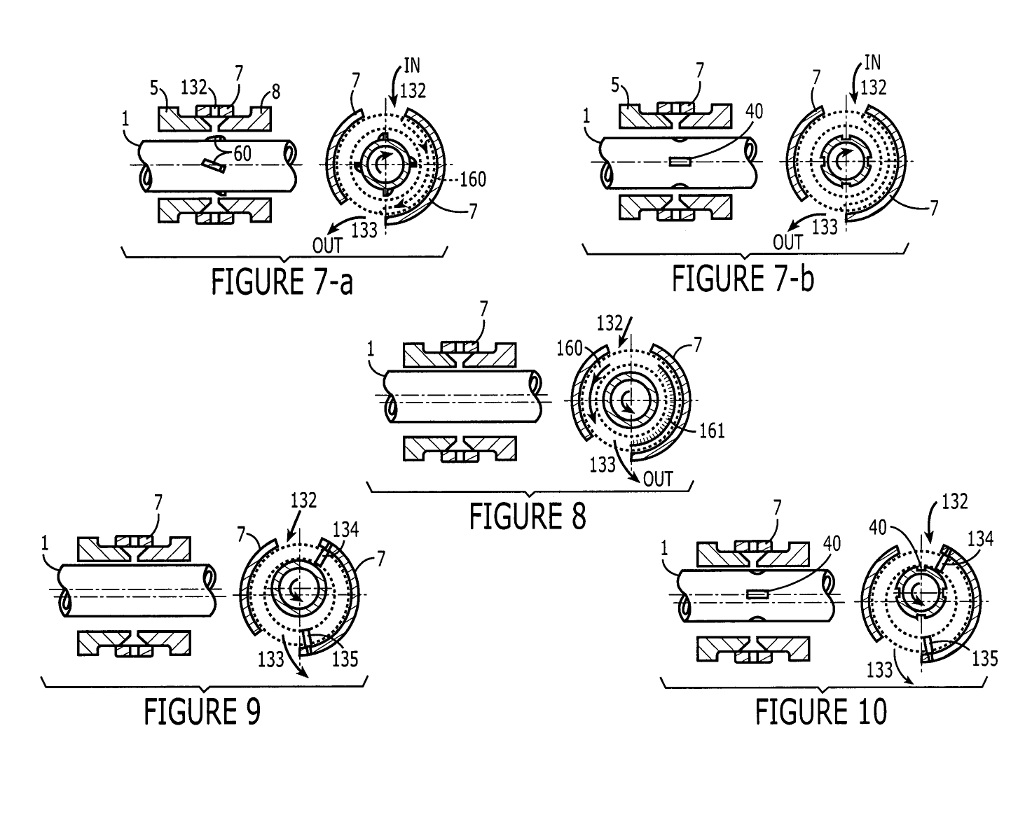

FIG. 7-a illustrates the effect of the pumping vanes 60 on the sleeve to circulate the barrier media from the in-port 132 to out-port 133. These vanes or grooves can be aligned with the axis of the shaft/sleeve to apply only centrifugal movement on the barrier media particles. These vanes can also have slight angles with the axis of rotation of the Shaft/Sleeve, to create some axial movement on barrier media particles. The vanes in FIG. 7-a have a slight angle with the axis of the shaft/sleeve. On the other hand the grooves in the sleeve in FIG. 7-b are aligned along the axis of the shaft/sleeve and therefore do not apply any axial movement on barrier media in the seal chamber. However an experienced reader will note the vanes can also be parallel to the axis or the grooves on the sleeve can also have an angle with the axis of the shaft/sleeve. The number of the vanes or grooves can also be reduced or increased. All the grooves or the vanes can have the same angle with the axis of the shaft/sleeve, or some of them have a different angle to the other ones. The type of the angles of the vanes or grooves can vary in a manner previously disclosed in GB 2,347,180.

FIG. 8 illustrates the effect of the eccentricity in between the rotary sleeve and self-aligning mechanism. This provides pressure differential in between the in & out ports of the self-aligning ring, and the barrier media will travel along the up-stream path 160 in this arrangement, from in-port 132 towards out-port 133.

FIG. 9 illustrates the effect of cut-water and eccentricity in between the ring 7 and sleeve 1. Pressure differential is generated in between the in-port 132 and out-port 133 due to the eccentricity of the rotating shaft and ring 7. Some part of the barrier media also rotates within ring 7, due to the frictional force in between the barrier media and the rotating shaft and also the viscosity of the barrier media. Whilst the barrier media is rotating around the ring 7, pin 135 provides an obstacle on front of the barrier media and leads the barrier media to the out-port 133 at the end of up-stream path 160. A rotational movement on the barrier media is also generated at the down-stream area 161, in which will have a tendency to move out of the ring from in-port 132 or out-port 133 in FIG. 8. This will reduce the amount of circulating the barrier media in the seal. However obstacle 134 in FIG. 9 prevents the circulating barrier media particles in the down-stream 161 to pass behind this point, and thus it will not interfere with the stream of the Barrier media at the in-port 132. Therefore the down-stream path 161 will be a dead zone for the barrier media that cannot radially escape from the space in between the sleeve 1 and ring 7. Pins 135 and 134 are referred as cutwater in this invention.

FIG. 10 is similar to FIG. 9, but illustrates the use of grooves 40 on the sleeve 1 to provide a better centrifugal force on the barrier media along the up-stream 160.

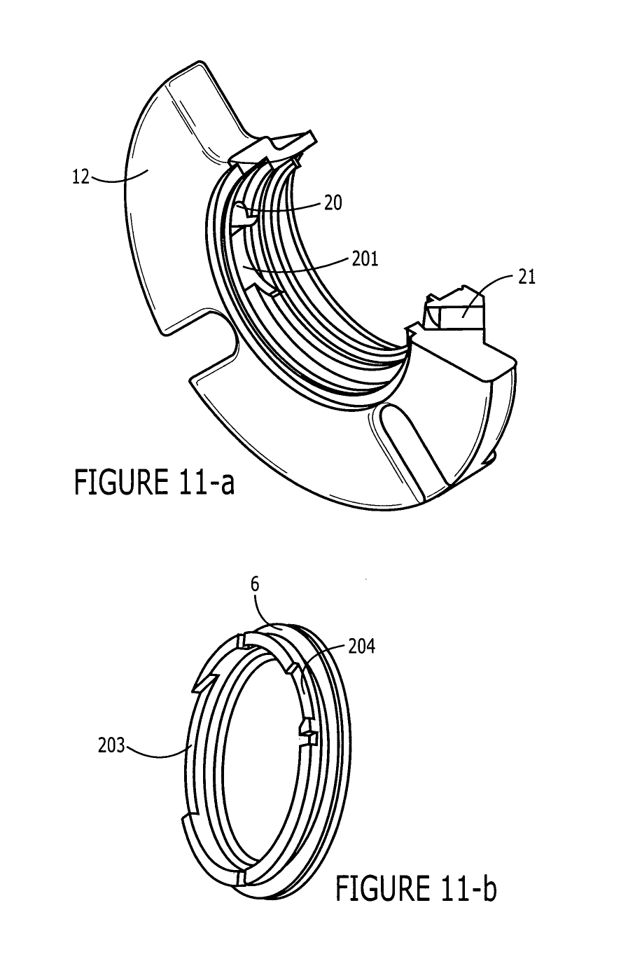

FIG. 11 illustrate the gland and the gland insert used in the mechanical seal of the invention. The ports on the gland 12 and gland insert 6 are designed to allow an easy path for the barrier media to travel into and out of the Ring 7. It is clear for a skilled person that the area around the in-port 20 and out-port 21 in FIG. 11-a, can be shaped as area 201 to allow the barrier media flow easily from the in-port 20 on the gland into the other parts, like ring 7. The same principle applies on the out-port 21 of the gland.

The same modification is also applied on the gland insert 6 to provide an smooth path for the barrier media to travel from the IN-Port 20 on the gland into the ring 7. These modifications on the gland Insert are shown as 203 and 204 on FIG. 11-b.

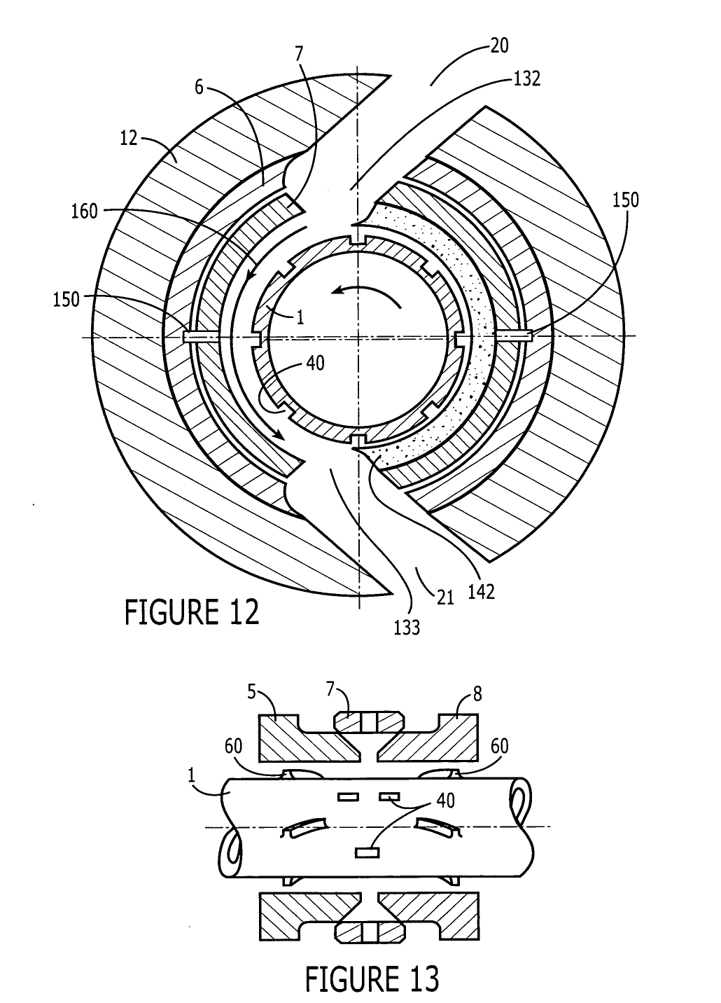

FIG. 12 illustrates a cross sectional view of the gland 12, gland-insert 6, Self-aligning ring 7 and rotary sleeve 1 in the seal assembly. This is to illustrate the path of the barrier media from the in-port 20 of the gland 12 into the in-port 132 of the self-aligning ring 7. The circumferential path (160), called up-stream, of the barrier media in the seal is also presented in this Figure. The angles on the gland and gland insert and also self-aligning ring at their in-ports, including the angle on the fin 142 would help to lead the barrier media towards up-stream path 160. There are some angles on the gland 12, gland-insert 6, and self-aligning ring 7 at the out-port that would help to lead the barrier media to exit the seal. The cutwater angle on fin 142, and the angle on exit port 133 of ring 7 and gland-insert 6 would help to lead the Barrier media to OUT-Port 21 on the gland 12. The sleeve is slightly off-centered to provide eccentricity effect on the barrier media. The sleeve contains some grooves to provide the pumping vane effect and fin 142 provides the cut-water effect. Two pins 150 on ring 7 provide pivoting effect on this ring relative to gland-insert 6.

FIG. 13 illustrates a number of staggered vanes (60) and grooves (40) on the sleeve 1. This is to illustrate the use of any combination of grooves and vanes on the sleeve which could provide a better distribution of the barrier media axially along the seal and also to help the barrier media to travel into and out of the seal via the in & out ports.

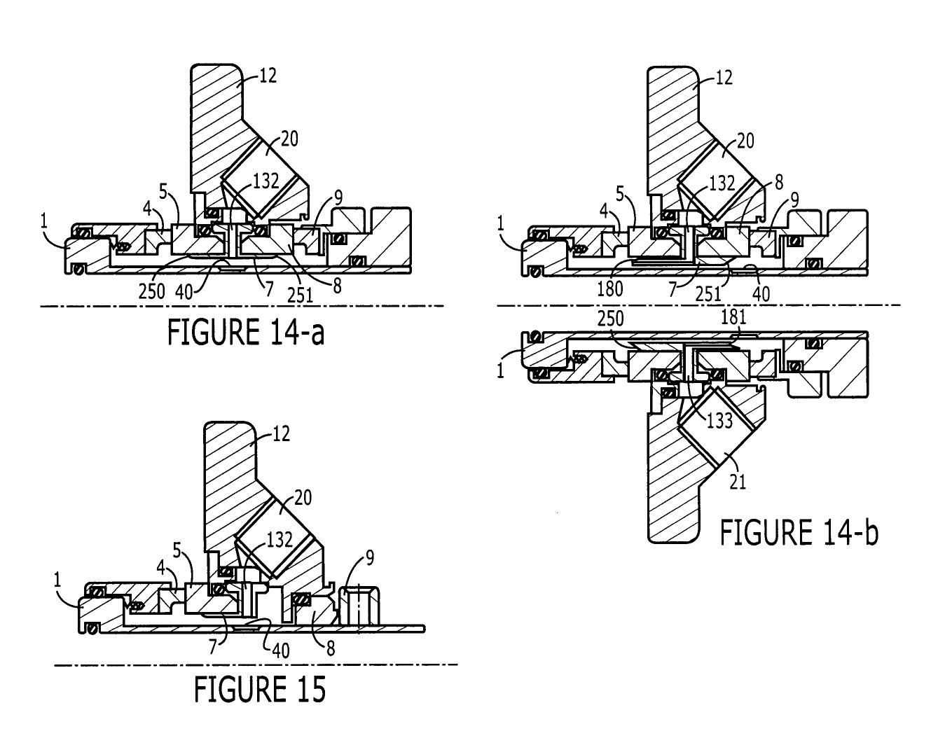

The self-aligning ring can be designed in different shapes, if there is enough space available in the seal chamber. FIGS. 14-a and 14-b illustrate two different designs for the self-aligning ring 7. The barrier media travels via the in-port 132 radially into the seal chamber and travels along the seal in FIG. 14-a. The self-aligning ring 7 is extended underneath of the stationary faces 5 & 8. This extension can also be designed in a format to provide eccentricity in between the rotary sleeve 1 and ring 7. Some angles at the inner side of the ring 7, where it extends underneath of the stationary faces, will work as deflector to lead the barrier media axially towards the seal faces. Some grooves are also located on the sleeve to work as pumping vanes in this assembly. These grooves may also be used to pump the barrier media axially to and from underneath of the faces from the in or to the out ports of the eing 7 respectively.

FIG. 14-b is similar to FIG. 14-a, but with extra axial holes on the self-aligning ring 7. Hole 180 will lead the barrier media from the IN-Port 132 to underneath of the seal faces 4 and 5. The angle 250 on the ring 7 work as deflector to move the barrier media axially to underneath of the seal faces. The barrier media then flows axially along the sleeve to the right hand side on this Figure. This flow can be helped by the use of eccentricity and pumping vanes. The pumping grooves 40 provide radial centrifugal force on the barrier media particles. The barrier media will reach underneath of the faces 8 & 9. The use of angle 251 at this side of the ring 7 would also help. The hole 181 will lead the barrier media to out-ports 133 and 21. It is considered self evident that different angles on ring 7 can be used as angles 180 and 181, to provide a better barrier media circulation. The whole body of ring 7 can also have a slight axial angle to help the barrier media circulation in FIG. 14-b. Pumping vanes can be used instead of grooves in this arrangement, and the position of the vanes or grooves can be altered along the sleeve for a more efficient pumping effect. The length of the extension of ring 7 underneath of either of the faces can also be modified for different type of barrier media or different applications. The size of axial holes 180 & 181 in ring 7 can also be modified based on the seal application. Some grooves or vanes can also be designed at the inner surface of the ring 7, close to sleeve 1 to help the barrier media circulation.

FIG. 15 illustrates the use of self-aligning mechanism in a single seal, where the outboard faces are simple lip-seals where they are referred as 8 & 9. This is considered self evident to an experienced reader that barrier media can be used in this type of single seals, and its circulation can be improved in the same way as it was explained for a double seal in previous figures.

The invention provides a number of advantages over the prior art. Self aligning technology is to align the axis of the rotating shaft and therefore the axis of rotary faces, to the axis of stationary faces. The eccentricity, cut-water and pumping vanes/grooves illustrated in FIGS. 8, 9 & 10 are only applied on the barrier media in the space 210 (in FIG. 5-a & 5-b).

It is considered self evident that the eccentricity can be positioned at any direction in the self-aligning mechanism in this invention. The cut-water effect can also be applied at any location inside the self-aligning mechanism. The vanes or grooves on the sleeve can also be provided by using an extra part on the sleeve and can be in any shape or numbers or at any angles.

The in-ports and out-ports on the self-aligning mechanism, the gland insert or the gland can also be shaped in a different format to allow the barrier media easily flow from the in-port on the gland into the inside of the seal nearby the seal faces, and then from the inside of the seal to the out-port on the gland as shown in FIG. 12. The number of the ports as in-port or out-port can also be altered for different applications. The angle of the in-port and out-port relative to the axis of the rotating shaft/sleeve or the axis of the housing, can also be modified to provide an easier path to the barrier media stream The shape of the pins on the self-aligning mechanism can also be altered.

The invention can be used in a triple seal as a rotary arrangement. This invention can also be applied on non-metallic parts or parts with different materials.

In concluding the detailed description, it should be noted that many variations and modifications can be made to the embodiments without substantially departing from the principles of the present invention. All such variations and modifications are intended to be included herein within the scope of the present invention, as set forth in the following claims.

1. A mechanical seal for sealing a rotatable shaft to a fixed housing, comprising: a first annular self-aligning member surrounding a shaft and attachable to a second stationary housing member, and a third annular member having a radial face for mating which corresponds to a radial face of a fourth rotary member, said first and third members have a means for permitting relative pivotal movement about a first axis between said first and third members and about a second axis at right angles to the first axis between the first annular member and second stationary housing, the seal further comprising means for modifying fluid flow radially inwardly of said first member.

2. A mechanical seal according to claim 1, wherein the flow modifying means comprises a cutwater in the form of a radially extending, part circumferential fin.

3. A mechanical seal according to claim 2, wherein said cutwater is located adjacent to a communication orifice between innermost and outermost radial parts of the stationary housing.

4. A mechanical seal according to claim 1, wherein said flow modifying means comprises a radially extending eccentric annular member.

5. A mechanical seal according to claim 2, wherein said cutwater is located adjacent to at least one radially extending feature on the rotating member.

6. A mechanical seal according to claim 2, wherein said seal comprises at least one set of counter-rotating seal faces, at least one of which one is mounted on the self-aligning member containing the cutwater adjacent to at least one communication orifice between innermost and outermost parts of said housing member.

7. A mechanical seal according to claim 2, wherein said seal comprises at least one set of counter-rotating seal faces, one of said seal faces, a stationary seat, being mounted on a self-aligning device which comprises an eccentric stationary member adjacent to the rotating member.

8. A mechanical seal according to claim 6, wherein the rotating seal face which is mounted on the self-aligning device is the stationary seat.

9. A mechanical seal according to claim 1, wherein the rotatable member comprises at least one circumferential radially displaced pumping vane.

10. A mechanical seal according to claim 1, wherein the mechanical seal comprises two rotary assemblies with radial faces and two stationary assemblies.

11. A mechanical seal according to claim 10, wherein stationary face members in the two stationary assemblies are positioned back to back and are arranged along the self-aligning ring member such that an annular gap channel is provided between the two stationary assemblies.

12. A mechanical seal according to claim 10, wherein both stationary assemblies have the same said axes of pivotal movement.

13. A mechanical seal according to claim 11, wherein said self-aligning ring is provided with at least one communication orifice extending from an inner surface to an outer surface, said orifice opening into to the annular gap channel to allow access from the inside of the self-aligning ring to the outer surface of the self-aligning ring.

14. A mechanical seal according to claim 10, wherein pivotal movement between a gland-insert member and the self-aligning ring within the stationary assemblies is generated by use of at least two lugs or pins provided on at least the gland-insert or the self-aligning ring.

15. A mechanical seal according to claim 14, wherein the lugs are common for the both of said stationary faces.

16. A mechanical seal according to claim 14, wherein each of said lugs or pins is located around 180° away from the other lug or pin along the annular surface of the self-aligning ring.

17. A mechanical seal according claim 16, wherein any combination of up to four lugs and/or up to four pins are provided on the self-aligning ring,

18. A mechanical seal according to claim 17, wherein two lugs or pins are provided for each of said stationary faces, and wherein for each stationary face, one lug or pin is located about 180° along the annular surface of the self-aligning ring from the other lug or pin.

19. A mechanical seal according to claim 14, wherein the lugs or pins are positioned such that they create a cut-water effect on the barrier media within the gap channel.

20. A mechanical seal according to claim 14, wherein the lugs extending into the gap channel have a curved profile for facilitating the flow of barrier media into and out of the gap channel.

21. A mechanical seal according to claim 11, wherein the rotational shaft or sleeve is eccentric to the centre of the two stationary faces, thereby creating a pressure differential in barrier media resulting in flow from an orifice provided within the self-aligning ring into the gap channel located in the back of said stationary faces.

22. A mechanical seal according to claim 21, wherein a distance between the rotational sleeve or shaft and the stationary faces is reduced by said eccentricity

23. A mechanical seal according to claim 21, wherein the barrier media travels in the same rotational direction, along the gap channel, as the rotational shaft or sleeve.

24. A mechanical seal according to claim 21, wherein the self aligning member is provided with IN and OUT port slots such that the barrier media flows into the gap channel from the slots located in the area that a distance in between the shaft or sleeve and the stationary faces is increased by the eccentricity, and the barrier media exits from the said gap channel from the other slot on the self-aligning ring.

25. A mechanical seal according to claim 24, wherein the self-aligning member is provided with more than one slot to allow the barrier media to flow in or out of the channel gap in between the back of said two stationary faces and said self-aligning member.

26. A mechanical seal according to claim 1, wherein at least one pumping vane or groove is provided on the rotatable shaft or a surrounding sleeve for circulating barrier media in the gap channel.

27. A mechanical seal according to claim 26, wherein the rotational shaft or sleeve is provided with at least one pumping vane and at least one pumping groove.

28. A mechanical seal according to claim 27, wherein the vane or groove is orientated parallel to the axis of rotation of the shaft or sleeve.

29. A mechanical seal according to claim 27, wherein the pumping vane or groove is orientated at an angle to the axis of the rotation on the shaft or sleeve thereby providing an axial pumping effect on the barrier media.

30. A mechanical seal according to claim 27, wherein the vanes or grooves are the same size.

31. A mechanical seal according to claim 27, wherein the vanes or grooves are orientated in the same direction

32. A mechanical seal according to claim 27, wherein the vanes or grooves are orientated at different axial angles to each other.

33. A mechanical seal according to claim 1, wherein the self-aligning member comprises at least two parts.

34. A mechanical seal according to claim 1, wherein an inner surface of the self-aligning member is provided with at least one vane or groove for directing the flow of the barrier media

35. A mechanical seal according to claim 1, wherein in- and/or out-ports provided on the housing member are adapted to facilitate the flow of barrier media into and out of the self aligning member.

36. A mechanical seal according to claim 35, wherein the ports are substantially curved shaped.

37. A mechanical seal according to claim 1, wherein the self-aligning member extends underneath a stationary seal face of said stationary housing member, thereby directing barrier media underneath said seal face.

38. A mechanical seal according to claim 1, wherein the seal is a single seal, double seal or triple seal.
